(19) United States
(12) Patent Application Publication
(10) Pub. No.: US 2007/0155450 A1
(43) Pub. Date: Jul. 5, 2007

(54) Portable electronic device

(75) Inventors: Ching-Yang Juan, Taoyuan (TW); Yuh-Huei Tsai, Taoyuan (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/638,460

(22) Filed: Dec. 14, 2006

(30) Foreign Application Priority Data
Jan. 3, 2006 (TW) 95100204

(51) Int. Cl. H04M 1/00

(52) U.S. Cl. 455/575.4

(57) ABSTRACT

A portable electronic device includes a main body, a sliding cover, and a transmission assembly. The sliding cover is disposed on the main body in a manner such that the sliding cover can slide within a fixed range. The transmission assembly is connected to the main body and the sliding cover respectively, and includes a sliding bearing and a drive element. The sliding bearing includes a sliding sleeve, a plurality of rolling balls, and a rotating shaft. The sliding sleeve includes a plurality of grooves, the rotating shaft includes a plurality of dents, and the rolling balls are disposed in the dents and the grooves simultaneously. The drive element is connected to the rotating shaft. When the drive element is started, the rotating shaft is driven to rotate, and the sliding sleeve is pushed to move linearly via the movement of the rotating balls.

### BACKGROUND OF THE INVENTION

1. Field of the Invention

The invention relates to a portable electronic device, and in particular to a portable electronic device with a fully-automatic sliding cover.

2. Description of the Related Art

Portable devices such as mobile phones, smart phones, and personal digital assistants are typically divided into four types: all in one, clamshell, rotating cover, and sliding keypad. Wherein the portable device with sliding keypad becomes increasingly popular in the market, as users are able to open or close the sliding cover with one hand, and its sliding cover is capable of integrating various operating interfaces.

The sliding cover of a conventional sliding keypad portable device is connected by a sliding mechanism which is disposed respectively on a main body and a sliding cover, and moves between a closed position and a full-open position. FIG. 1 shows a conventional sliding mechanism 10, wherein a hinge 11 slides along a track 12. The disadvantage of the conventional sliding mechanism 10 is that the width of span length D is too narrow to fit a sliding keypad portable device or a sliding mechanism with large span length.

Furthermore, a conventional sliding cover is operated manually such that users must repeatedly apply forces to slide the sliding cover between a closed position and a full-open position, leading to user discomfort.

### BRIEF SUMMARY OF INVENTION

The present invention provides an improved portable electronic device, and in particular a portable electronic device for a side-sliding keypad or a sliding cover with large span length. Furthermore, the portable electronic device is automatically sliding, and reduces manual operation.

The portable electronic device comprises a main body, a sliding cover, and a transmission assembly. The sliding cover is disposed on the main body in a manner such that the sliding cover can slide within a fixed range. The transmission assembly is connected to the main body and the sliding cover respectively, and comprises a sliding bearing and a drive element, wherein the drive element can be a motor or a stepping motor. The sliding bearing comprises a sliding sleeve, a plurality of rolling balls, and a rotating shaft. The sliding sleeve comprises a plurality of grooves, the rotating shaft comprises a plurality of dents, and the rolling balls are simultaneously disposed in the dents and the grooves. The motor is connected to the rotating shaft. When the drive element is started, the rotating shaft is driven to rotate, and the sliding sleeve is pushed to move linearly via the movement of the rotating balls.

The portable electronic device of the invention can be a smart phone, a personal digital assistant, a mobile phone, or similar.

### BRIEF DESCRIPTION OF DRAWINGS

The present invention can be more fully understood by reading the subsequent detailed description and examples with references made to the accompanying drawings, wherein:

FIG. 1 is a perspective view of a conventional sliding mechanism;

FIG. 2 is a perspective view of an embodiment of a portable electronic device;

FIG. 3A is perspective view of a transmission assembly in FIG. 2;

FIG. 3B is a side view of the transmission assembly in FIG. 2;

FIG. 4A is a perspective view of a sliding sleeve;

FIG. 4B is a cross-section view showing the sliding sleeve in FIG. 4A;

FIG. 5A is a top view of a sliding cover located at a full-open position on a main body;

FIG. 5B is a side view of the sliding cover located at the full open position on the main body;

FIG. 6A is a top view of the sliding cover located at a closed position on the main body; and

FIG. 6B is a side view of the sliding cover located at the closed position on the main body.

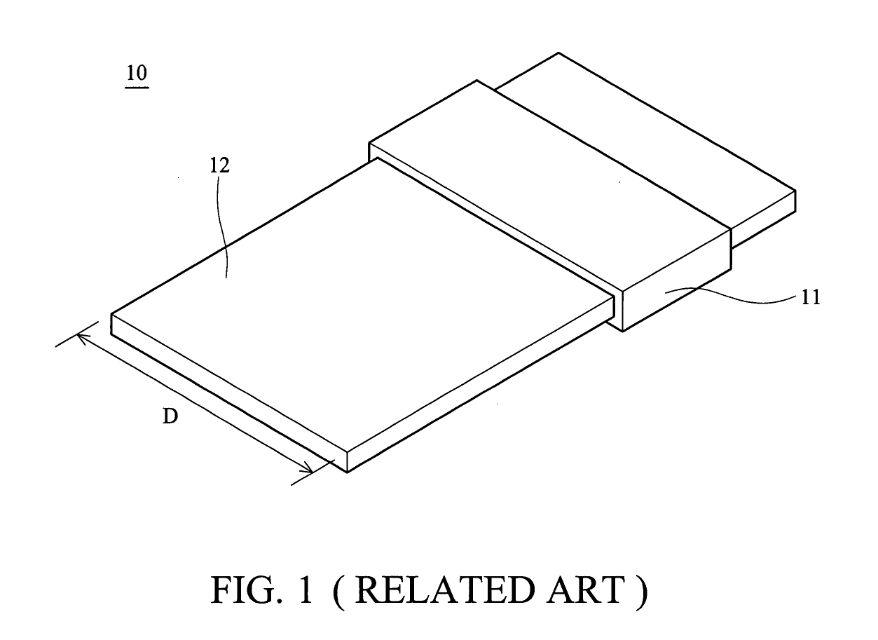

### DETAILED DESCRIPTION OF INVENTION

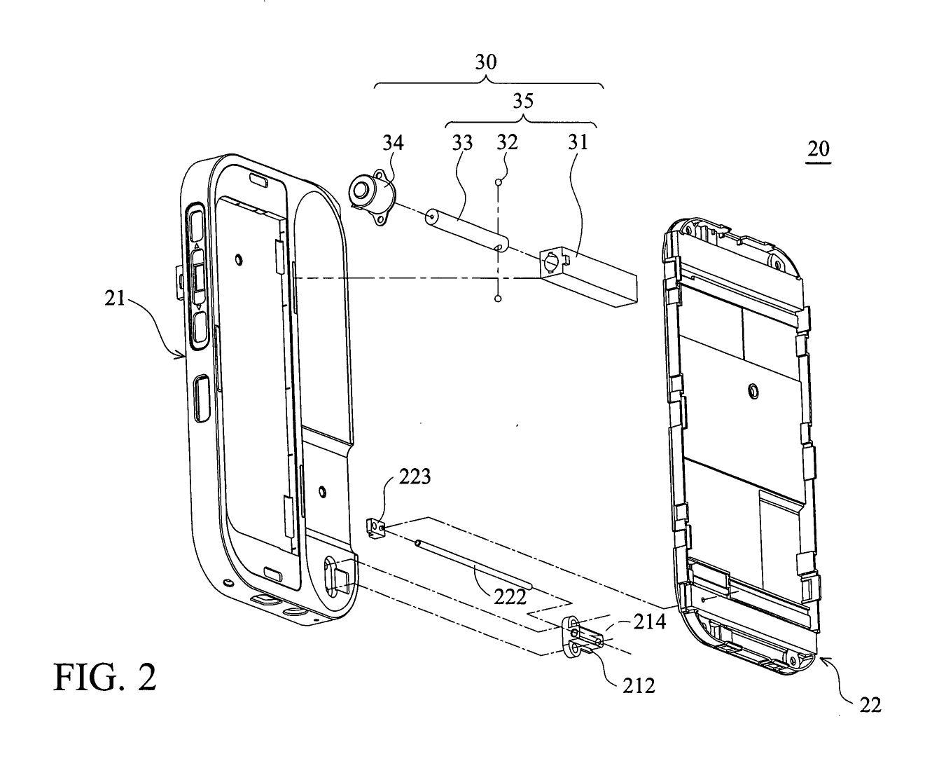

Referring to FIG. 2, an embodiment of a portable electronic device 20 comprises a main body 21, a sliding cover 22, and a transmission assembly 30.

The main body 21 comprises a shaft shroud 212, the shaft shroud 212 is mounted on a bottom of main body 21, and a surface of the shaft shroud 212 is made of self-lubricating plastic, wherein the self-lubricating plastic can be Polyoxymethylene (POM). Furthermore, the shaft shroud 212 comprises a shaft hole 214 for insertion of a sliding shaft 222.

The sliding cover 22 is disposed on the main body 21 in a manner such that the sliding cover 22 can slide within a fixed range. The fixed range is defined by bounded positions on the main body 21 for the sliding cover 22. The sliding cover 22 comprises a fixing stand 223 and a sliding shaft 222, wherein the fixing stand 223 is mounted on the bottom of sliding cover 22. The sliding shaft 222 is mounted in the fixing stand 223, and slidably inserted into the shaft hole 214 on the shaft shroud 212. The sliding shaft 222 is made of stainless steel with a high surface finish which has the characteristics of being rustproof and having a low surface contact friction.

The transmission assembly 30 is disposed respectively on tops of the main body 21 and the sliding cover 22, and respectively connected to the main body 21 and the sliding cover 22. The transmission assembly 30 comprises a sliding bearing 35 and a drive element (not shown in figure), wherein the drive element can be a motor 34 and the sliding bearing 35 comprises a sliding sleeve 31, two rolling balls 32, and a rotating shaft 33, all of which are described in the following.

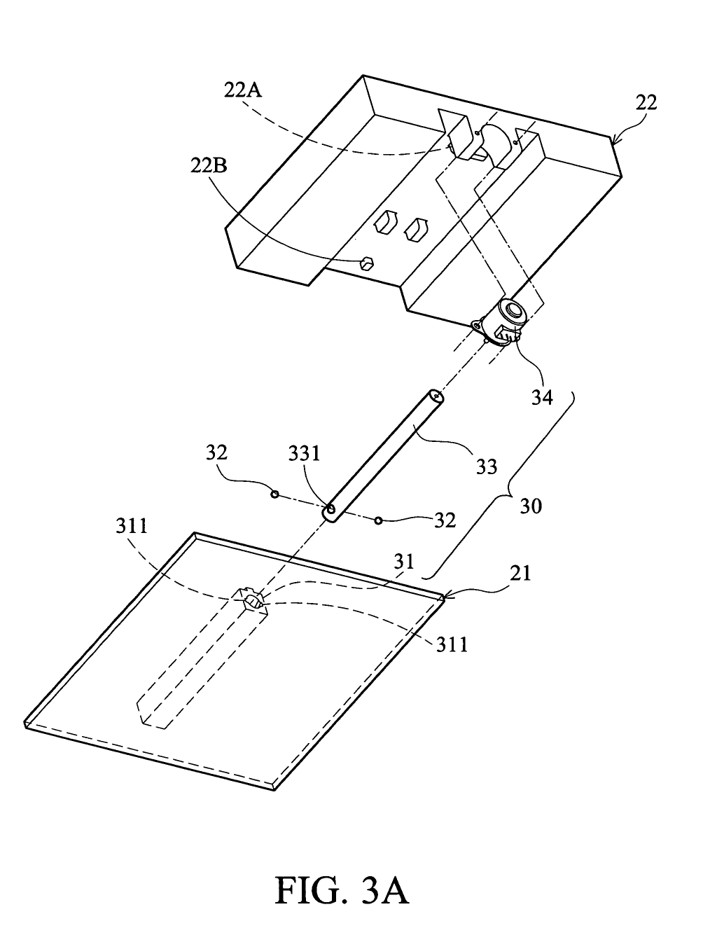

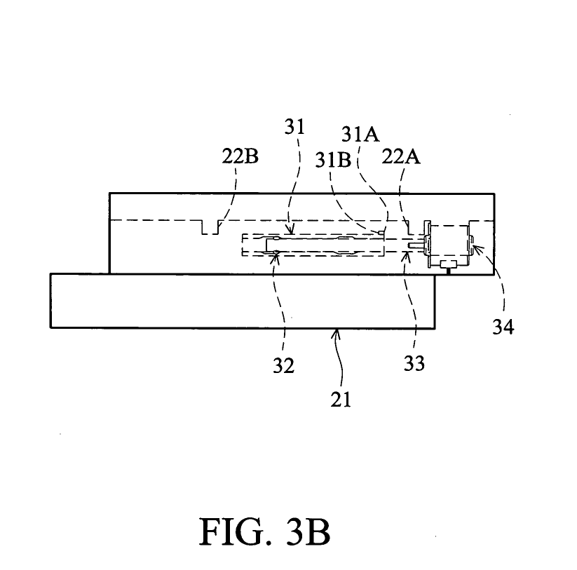

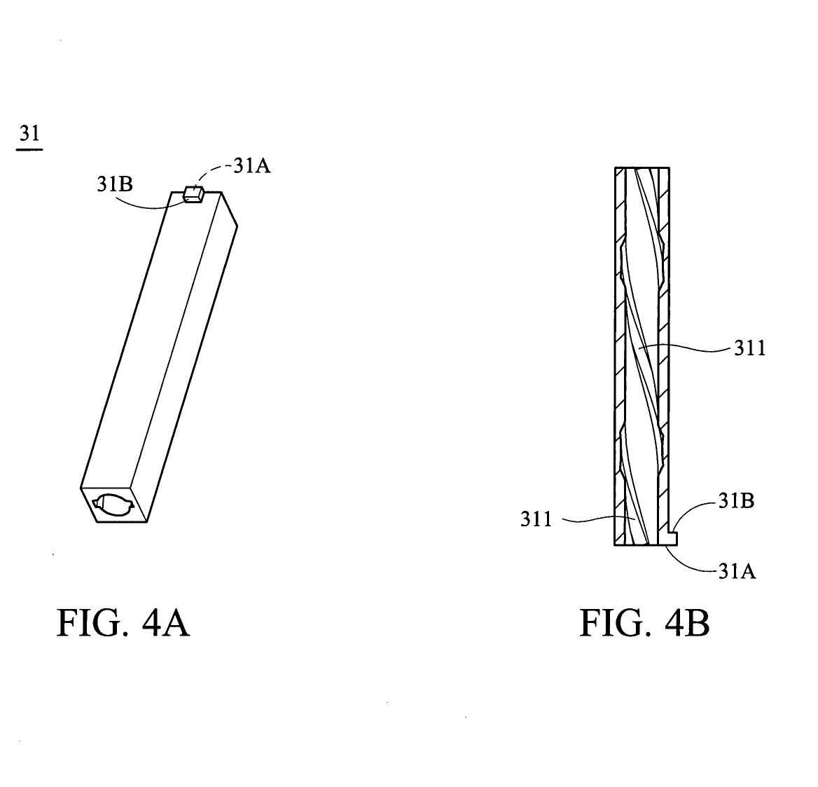

FIG. 3A is a perspective view of an embodiment of the transmission assembly 30, and FIG. 3B is a side view of the embodiment of the transmission assembly 30, wherein the motor 34 is mounted on the sliding cover 22, and the rotating shaft 33 is connected to the motor 34 and comprises two dents 331 (one shown in FIG. 3A). The sliding sleeve 31 is mounted on the main body 21, and comprises a second restraint surface 31A, a fourth restraint surface 31B, and two grooves 311. The geometric contour of the grooves 311 is a section swept along a helical trajectory curve (shown in FIGS. 4A and 4B), wherein the section can be a trapezoid or a semi-ellipse (not shown in figure), which can be fabricated by boring process. The two rolling balls 32 are fitted into the two dents 331 and engaged into two grooves 311 sequentially. When the motor 34 starts to drive the rotating shaft 33 to rotate, the two rotating balls 32 fitted in the dents 331 simultaneously rotate along the rotating shaft 33, the movement of rotating balls 32 drives the sliding sleeve 31 to move linearly via the helical trajectory curve of the grooves 311, and correspondingly drives the sliding cover 22 to move linearly.

The rotating shaft 33, the rolling balls 32, and the sliding sleeve 31 are made of a metal material, and an outer surface of the rolling ball 32 has a high surface finish for reducing friction due to the relative movement between the dents 331 and the grooves 311.

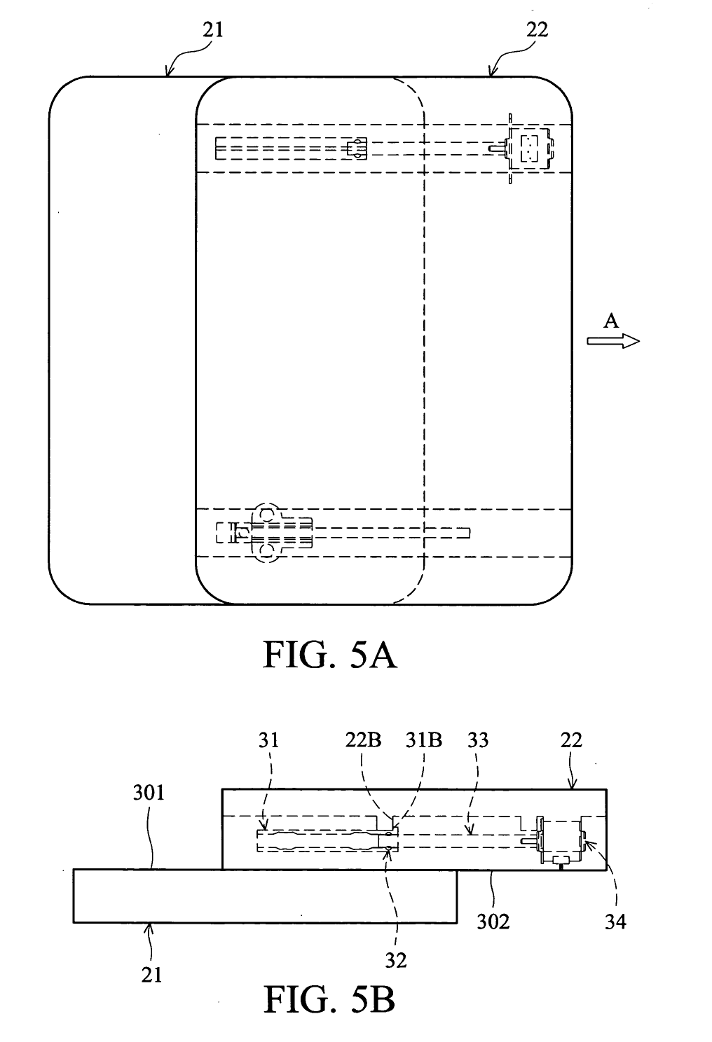

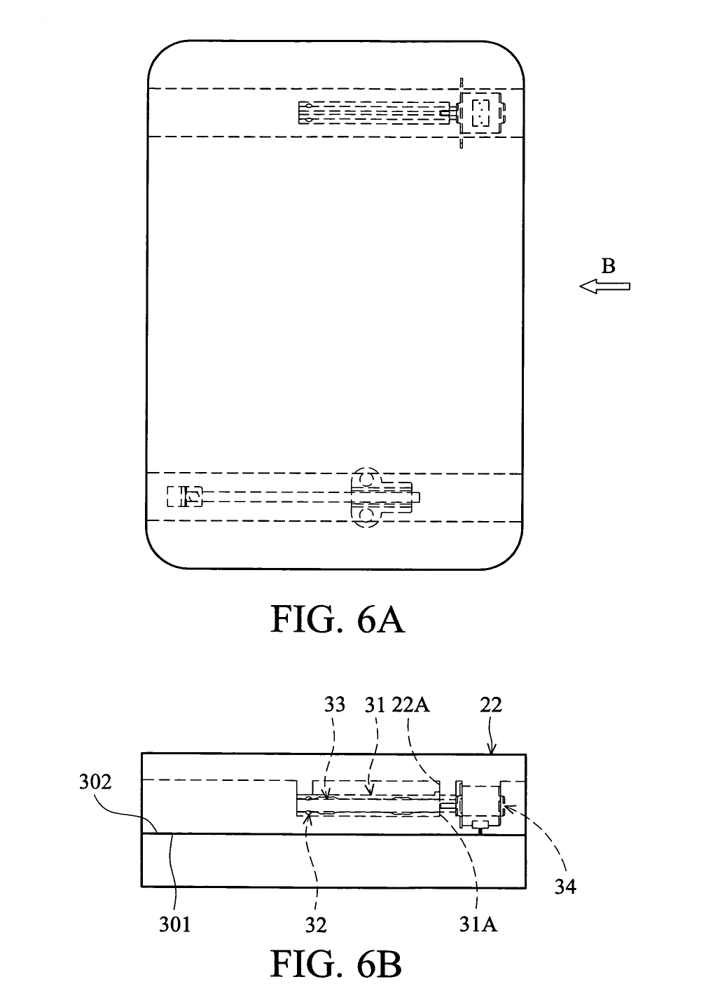

The sliding cover 22 is disposed on the main body 21 such that the sliding cover 22 is sliding between a closed position (see FIG. 6A) and a full-open position (see FIG. 5A), the full-open position and the closed position are bounded positions of the sliding cover 22 on the main body 21. The sliding cover 22 comprises a first restraint surface 22A and a third restraint surface 22B, wherein the first restraint surface 22A and the second restraint surface 31 A on the sliding sleeve 31 define the closed position of the sliding cover 22 on the main body 21, and the third restraint surface 22B and the fourth restraint surface 31B on the sliding sleeve 31 define the full-open position of the sliding cover 22 on the main body 21. The fixed sliding range described in the above is defined by both the closed position and the full-open position.

The motor 34 may be electrically connected to a single button (not shown in figures), and the single button is used to automatically control the sliding movement of the sliding cover 22 instead of repeated manual operations of the sliding cover 22. The motor 34 may further be a stepping motor or a micro stepping motor comprising a rotating angle which is precisely controlled by a pulse signal, and the rotating angle is adjustable according to design requirements such that the sliding movement of the sliding cover 22 is accurately controlled without a feedback encoder, and the control operation is simpler.

Referring to FIG. 5A and FIG. 5B, FIG. 5A and FIG. 5B show the sliding cover 22 at the full-open position on the main body 21. The main body 21 further comprises a first abutting surface 301, and the sliding cover 22 further comprises a second abutting surface 302 which is corresponding to the first abutting surface 301. The sliding cover 22 moves along direction A until the third restraint surface 22B on the sliding cover 22 leans against the fourth restraint surface 31B which is on the sliding sleeve 31. Meanwhile, the overlapping area between the first abutting surface 301 and the second abutting surface 302 is at the minimum, and the exposure area of the first abutting surface 301 is at the maximum. For a portable electronic device with sliding keypad, the maximum exposure area of the first abutting surface 301 is available for installing elements such as a keypad, a screen display, or buttons.

FIGS. 6A and 6B show the sliding cover 22 at the closed position on the main body 21. The sliding cover 22 moves along direction B until the first restraint surface 22A on the sliding cover 22 leans against the second restraint surface 31A on the sliding sleeve 31. Meanwhile, the second abutting surface 302 totally overlaps the first abutting surface 301.

Therefore, a distance between a sliding shaft 33 and a sliding sleeve 31 of a portable electronic device 20 is not as limited as the width of the span length D of a conventional transmission mechanism 10, and can be applied to a sidekick-esque portable electronic device or a transmission mechanism with a large span length. Further, a sliding cover 22 can automatically slide between a full-open position and a closed position via electrical connection to a drive element, which solves the problem of repeatedly applying manual force to move the sliding cover 22.

In another embodiment (not shown in figure) of the invention, the connection of the transmission assembly between a main body and a sliding cover is changed, wherein a motor is disposed on the main body and a sliding sleeve is disposed on the sliding cover. Further, the main body comprises a first restraint surface and a third restraint surface, and the sliding sleeve comprises a second restraint surface and a fourth restraint surface. The first restraint surface and the second restraint surface defines the full-open position of sliding cover on the main body, the third restraint surface and the fourth restraint surface of the sliding sleeve defines the closed position of sliding cover on the main body. The movement of the sliding cover on the main body is similar as the former embodiment of the invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device comprising:
a main body;
a sliding cover disposed on the main body such that the sliding cover can be slid in a fixed range; and
a transmission assembly connected to both the main body and the sliding cover, comprising a drive element and a sliding bearing which is connected to the drive element, wherein the sliding bearing drives the sliding cover slid within the fixed range when the drive element starts.

2. The portable electronic device as claimed in claim 1, wherein the main body comprises at least one sliding shroud, and the sliding cover comprises at least one sliding shaft which is slid into the sliding shroud.

3. The portable electronic device as claimed in claim 1, wherein the sliding cover comprises a full-open position and a closed position on the main body, and the fixed range is defined by the full-open position and the closed position.

4. The portable electronic device as claimed in claim 3, wherein the main body comprises a first abutting surface and the sliding cover comprises a second abutting surface corresponding to the first abutting surface; the first abutting surface fully overlaps the second abutting surface when the sliding cover slides to the closed position, and the overlapping area between the first abutting surface and the second abutting surface is at the minimum when the sliding cover slides to the full-open position.

5. The portable electronic device as claimed in claim 3, wherein the sliding bearing further comprises:
a rotating shaft connected to the drive element, comprising a plurality of dents;
a sliding sleeve comprising a plurality of grooves; and
a plurality of rolling balls disposed into the grooves and the dents.

6. The portable electronic device as claimed in claim 5, wherein the rotating shaft, the rolling ball, and the sliding sleeve are made of metal.

7. The portable electronic device as claimed in claim 5, wherein the geometric contour of the grooves is a section swept along a helical trajectory curve.

8. The portable electronic device as claimed in claim 7, wherein the section is a trapezoid or a semi-ellipse.

9. The portable electronic device as claimed in claim 5, wherein the drive element is a motor or a stepping motor.

10. The portable electronic device as claimed in claim 5, wherein the sliding sleeve is disposed on the main body, and the drive element is disposed on the sliding cover.

11. The portable electronic device as claimed in claim 10, wherein the sliding cover comprises a first restraint surface and the sliding sleeve comprises a second restraint surface, the first restraint surface and the second restraint surface define the closed position of the sliding cover.

12. The portable electronic device as claimed in claim 10, wherein the sliding cover comprises a third restraint surface and the sliding sleeve comprises a fourth restraint surface, the third restraint surface and the fourth restraint surface define the full-open position of the sliding cover.

13. The portable electronic device as claimed in claim 5, wherein the sliding sleeve is disposed on the sliding cover, and the drive element is disposed on the main body.

14. The portable electronic device as claimed in claim 13, wherein the main body comprises a first restraint surface and the sliding sleeve comprises a second restraint surface, the first restraint surface and the second restraint surface define the closed position of the main body.

15. The portable electronic device as claimed in claim 13, wherein the main body comprises a third restraint surface and the sliding sleeve comprises a fourth restraint surface, the third restraint surface and the fourth restraint surface define the full-open position of the main body.

16. The portable electronic device as claimed in claim 1, wherein the drive element is a motor or a stepping motor.

17. The portable electronic device as claimed in claim 1, wherein the portable electronic device is a portable electronic device with sliding keypad.

18. The portable electronic device as claimed in claim 1, wherein the portable electronic device is a mobile phone, a smart phone, or a personal digital assistant.

19. A transmission assembly for a portable electronic device, comprising:
a sliding sleeve comprising a plurality of grooves;
a rotating shaft comprising a plurality of dents;
a plurality of rolling balls disposed on the grooves and the dents; and
a drive element connected to the rotating shaft, driving the sliding sleeve to slide via the rolling balls when the drive element starts.

20. The transmission assembly as claimed in claim 19, wherein the drive element is a motor or a stepping motor.
